(19) United States
(12) Patent Application Publication
(10) Pub. No.: US 2016/0113022 A1
(43) Pub. Date: Apr. 21, 2016

(54) CONTROL DEVICE AND CONTROL METHOD

(71) Applicant: FUJITSU LIMITED, Kawasaki-shi (JP)

(72) Inventors: Masafumi Tsutsui, Kawasaki (JP); Hiroyuki Seki, Kamakura (JP); Teppei Oyama, Kawasaki (JP)

(73) Assignee: FUJITSU LIMITED, Kawasaki-shi (JP)

(21) Appl. No.: 14/976,576

(22) Filed: Dec. 21, 2015

Related U.S. Application Data
(63) Continuation of application No. PCT/JP2013/067931, filed on Jun. 28, 2013.

(51) Int. Cl. H04W 72/08; H04W 24/08

(52) U.S. Cl. CPC H04W 72/082; H04W 24/08

(57) ABSTRACT

A control device includes a calculating unit and a specifying unit. The calculating unit calculates an estimated interference area of a base station to be installed for a secondary system, based on an installation scheduled position of the base station to be installed, an installation position of a reference base station of the secondary system, and an actually-measured interference area of the reference base station. The specifying unit specifies a channel of a primary system for which a used area does not overlap with the calculated estimated interference area.

### CROSS-REFERENCE TO RELATED APPLICATION

This application is a continuation application of International Application No. PCT/JP2013/067931, filed on Jun. 28, 2013 and designating the U.S., the entire contents of which are incorporated herein by reference.

### FIELD

The embodiments discussed herein are related to a control device and a control method.

### BACKGROUND

To improve the use efficiency of frequency channels, secondary use of frequency channels prepared for a primary system has been studied. Specifically, there is a study to allow a secondary system to use a free channel (that is, a white space) among the frequency channels prepared for the primary system. A system in which a plurality of systems share a single frequency channel may be referred to as a cognitive system.

Representative examples of the primary system include a TV broadcasting system. There is a study to use a white space of the TV broadcasting system (hereinafter, may be referred to as a TV white space) in the secondary system without granting a license to the secondary system. In Europe and the United States, institutionalization for use of the TV white space by the secondary system and standardization of the secondary system are already in progress. Examples of the secondary system include a wireless communication system.

In the United States, the Federal Communications Commission (FCC) has defined a method to use the TV white space by the wireless communication system. In this method of use, a database is used. Specifically, a base station belonging to the secondary system transmits, to a database, information on a position at which the base station is installed. Then, the database calculates an “interference area” of the base station by using a radio wave propagation model. Specifically, the database calculates electric power of radio wave emitted from the base station at each position by using the propagation model, and calculates an area including a position at which the calculated electric power is equal to or greater than a predetermined threshold. The database may calculate the “interference area” of the base station by expanding the calculated area by a predetermined value. Specifically, the database may employ, as the interference area, an area obtained by setting a predetermined margin in the calculated area. Then, the database specifies a frequency channel of the primary system for which a used area does not overlap with the calculated interference area, and transmits a list of the specified frequency channel (that is, a white space list) to the base station. The base station communicates with a communication device controlled by the base station, by using the frequency channel contained in the white space list. The above-described process is performed every time a base station is introduced in the secondary system, for example.

Patent Document 1: Japanese Laid-open Patent Publication No. 2012-213071

However, while the propagation model is used in the related method to calculate the interference area, there may be a case in which the propagation model does not fit an area in which a base station of the secondary system is to be installed. In this case, the accuracy of calculating the interference area may be reduced. If interference with the primary system is to be prevented even with the reduced accuracy of calculating the interference area, a greater margin may be set as the margin as described above. However, in this case, free channels of the primary system available to the secondary system may be reduced. That is, to improve the convenience of the secondary system, it is desired to improve the accuracy of calculating the interference area.

### SUMMARY

According to an aspect of the embodiments, a control device includes: a calculating unit that calculates an estimated interference area of a base station to be installed for a secondary system, based on an installation scheduled position of the base station to be installed, an installation position of a reference base station of the secondary system, and an actually-measured interference area of the reference base station; and a specifying unit that specifies a channel of a primary system for which a used area does not overlap with the calculated estimated interference area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a cognitive system according to a first embodiment;

FIG. 2 is a block diagram illustrating an example of a control device according to the first embodiment;

FIG. 3 is a diagram illustrating an example of a used resource table;

FIG. 4 is a diagram illustrating an example of a reference base station information table;

FIG. 5 is a diagram illustrating an example of a to-be-installed base station information table;

FIG. 6 is a flowchart illustrating an example of a processing operation performed by the control device according to the first embodiment;

FIG. 7 is a diagram for explaining a surrounding environment index a;

FIG. 8 is a diagram for explaining a process of correcting an estimated interference area; and

FIG. 9 is a diagram illustrating a hardware configuration example of the control device.

### DESCRIPTION OF EMBODIMENTS

Preferred embodiments will be explained with reference to accompanying drawings. The control device and the control method disclosed in the application are not limited by the embodiments. In the embodiments, components with the same functions are denoted by the same symbols, and the same explanation will not be repeated.

### [a] First Embodiment

System Configuration

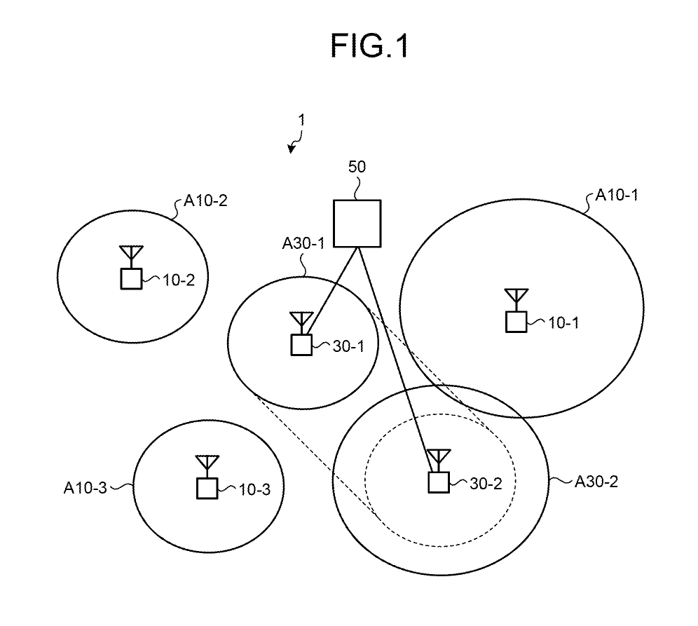

FIG. 1 is a diagram illustrating an example of a cognitive system according to a first embodiment. In FIG. 1, a cognitive system 1 includes base stations 10-1 to 10-3 of a primary system, base stations 30-1 and 30-2 of a secondary system, and a control device 50. The base station 30-1 is a base station already installed for the secondary system, and the base station 30-2 is a base station to be installed for the secondary system. While the number of the base stations 10 of the primary system is three and the number of the base stations 30 of the secondary system is two in FIG. 1, the numbers are not limited to this example. In the following, the base stations 10-1 to 10-3 may be collectively referred to as the base stations 10 when they are not distinguished from one another, and the base stations 30-1 and 30-2 may be collectively referred to as the base stations 30 when then are not distinguished from each other.

Furthermore, in FIG. 1, areas A10-1 to A10-3 are “used areas” used by the base stations 10-1 to 10-3 of the primary system, respectively. The “used areas” are areas in which signals transmitted from the base stations 10-1 to 10-3 of the primary system are reachable. Each of the base stations 10-1 to 10-3 of the primary system uses one or more frequency channels from among a plurality of frequency channels (hereinafter, may be referred to as a “frequency channel set”) assigned to the primary system.

Moreover, in FIG. 1, the area A30-1 is an actually-measured “interference area” caused by the base station 30-1. The “interference area” is an area of the secondary system that may interfere with the primary system when overlapping with the used area of the primary system. In FIG. 1, the interference area A30-1 does not overlap with the used area of the primary system, so that the base station 30-1 can use all of the frequency channels contained in the frequency channel set of the primary system.

If an administrator of the secondary system is to install the base station 30-2 that is scheduled to be installed, the base station 30-2 is connected to the control device 50. Then, the base station 30-2 transmits information on a scheduled position at which the base station 30-2 is to be installed (hereinafter, may be simply referred to as an “installation scheduled position information”) to the control device 50.

The control device 50 stores therein information on the used areas of the primary system (hereinafter, may be referred to as “used area information”). Furthermore, the control device 50 stores therein information on an installation position of a reference base station of the secondary system (hereinafter, may be referred to as “installation position information”) and information on an actually-measured interference area of the reference base station (hereinafter, may be referred to as “interference area information”). Here, the “reference base station” of the secondary system is a base station whose interference area is actually measured, and the base station 30-1 in FIG. 1 corresponds to the reference base station.

Then, the control device 50 calculates an “estimated interference area” of the base station 30-2 based on the installation scheduled position information received from the base station 30-2, the installation position information on the reference base station, and the interference area information. The “estimated interference area” is an area in which the base station to be installed for the secondary system may interfere with the primary system. In FIG. 1, an area A30-2 corresponds to the estimated interference area. Furthermore, the control device 50 stores therein information on the calculated estimated interference area (hereinafter, may be referred to as an “estimated interference area information”).

Then, the control device 50 specifies a frequency channel (hereinafter, may be referred to as a “white channel”) of the primary system for which a used area does not overlap with the calculated estimated interference area. In FIG. 1, the estimated interference area A30-2 and the used area A10-1 overlap with each other. Therefore, the frequency channel used by the base station 10-1 is excluded from the white channels. In other words, the control device 50 specifies, as the white channels, the frequency channels except for the frequency channel used by the base station 10-1 in the frequency channel set.

Then, the control device 50 transmits information on the specified white channels (that is, the white space list as described above) to the base station 30-2. Therefore, the base station 30-2 can start operation by using a white channel.

As described above, the estimated interference area is calculated by using the installation position of the reference base station and the interference area that are actually measured, so that it is possible to improve the accuracy of calculating the interference area. Furthermore, the estimated interference area of the base station to be installed can be obtained not by measurement but by a calculation process, so that it is possible to reduce the workload of the administrator of the secondary system.

When the base station 30-2 is actually installed and operation of the base station 30-2 is started, the base station 30-2 wirelessly transmits a known signal. A communication device (not illustrated) that has received the known signal transmitted by the base station 30-2 transmits information on a reception level of the known signal and on the position of the communication device to the control device 50 via the base station 30-2.

Then, the control device 50 acquires the information on the reception level of the known signal and on the position of the communication device (not illustrated) transmitted from the communication device (not illustrated), and corrects the stored estimated interference area information based on the acquired information. Therefore, it is possible to correct the estimated interference area, which has been obtained through the calculation process, by measurement.

Configuration Example of Control Device

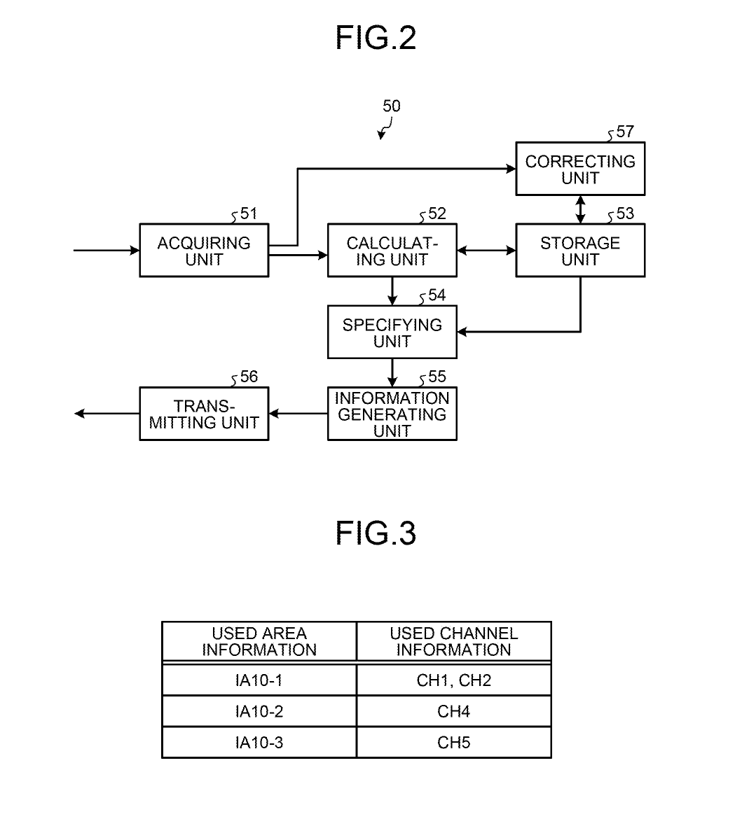

FIG. 2 is a block diagram illustrating an example of the control device according to the first embodiment. In FIG. 2, the control device 50 includes an acquiring unit 51, a calculating unit 52, a storage unit 53, a specifying unit 54, an information generating unit 55, a transmitting unit 56, and a correcting unit 57.

The acquiring unit 51 acquires the installation scheduled position information transmitted from the base station 30-2 to be installed, and outputs the information to the calculating unit 52. When operation of the base station 30-2 is started, the acquiring unit 51 acquires the information on the reception level of the known signal and on the position of the communication device transmitted from communication device as described above, and outputs the information to the correcting unit 57.

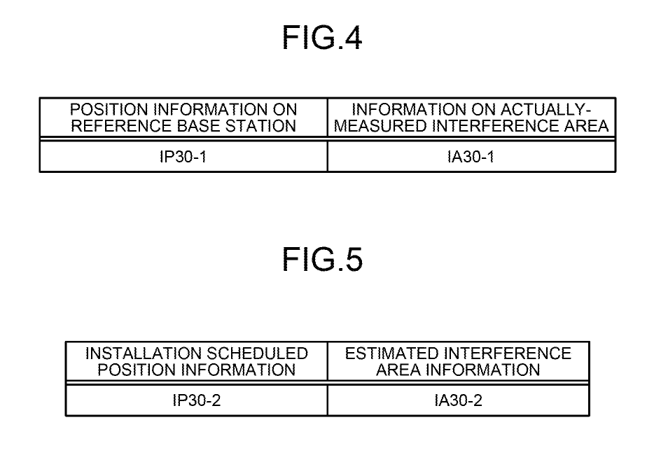

The storage unit 53 stores therein a “used resource table”, a “reference base station information table”, and a “to-be-installed base station information table”. FIG. 3 is a diagram illustrating an example of the used resource table. FIG. 4 is a diagram illustrating an example of the reference base station information table. FIG. 5 is a diagram illustrating an example of the to-be-installed base station information table.

In the “used resource table”, as illustrated in FIG. 3 for example, a plurality of used areas of the primary system and used channels corresponding to the respective used areas are associated with one another. In FIG. 3, for example, used area information IA10-1 indicates information on the used area A10-1. Each piece of the used area information includes a position at which the corresponding base station 10 is installed (hereinafter, referred to as a “reference point”), and information on extent of an area with reference to the reference point (hereinafter, referred to as “relative area information”).

In the “reference base station information table”, as illustrated in FIG. 4 for example, a position at which the reference base station is installed and an actually-measured interference area of the the reference base station are associated with each other. In FIG. 4, location information IP30-1 on the reference base station indicates information on the position at which the base station 30-1 is installed (that is, the reference point). Furthermore, measured interference area information IA30-1 indicates a relative area with reference to the reference point at which the base station 30-1 is installed.

In the “to-be-installed base station information table”, as illustrated in FIG. 5 for example, an installation scheduled position, at which a to-be-installed based station of the secondary system is to be temporarily installed, and a calculated estimated interference area are associated with each other. In FIG. 5, installation scheduled position information IP30-2 indicates information on a position at which the base station 30-2 is temporarily installed (that is, the reference point). Furthermore, estimated interference area information IA30-2 indicates a relative area with reference to the reference point at which the base station 30-2 is temporarily installed.

The calculating unit 52 calculates an estimated interference area based on the installation scheduled position information received from the acquiring unit 51, and based on the installation position information and the interference area information on the reference base station stored in the reference base station information table. For example, the calculating unit 52 calculates an expansion value based on a parameter including a “separation relation” between the installation scheduled position and the installation position of the reference base station. Then, the calculating unit 52 expands the relative area of the reference base station by using the calculated expansion value, to thereby calculate the estimated interference area. Here, the “separation relation” may include a separate distance between the the installation scheduled position and the installation position of the reference base station. Furthermore, the “separation relation” may include a difference in height between the installation scheduled position and the installation position of the reference base station. Moreover, the parameter used to calculate the expansion value may include a “surrounding environment index” of the installation scheduled position. The surrounding environment index is, for example, the occupancy of a building at a certain point. Incidentally, it may be possible to represent the measured interference area by a distance propagation characteristics P_{β}=β log₁₀(d), and directly obtain the estimated interference area by substituting β with a value β′ corresponding to the base station 30-2. That is, in this case, the estimated interference area is represented by the distance propagation characteristics P_{β}=β′ log₁₀ (d).

Then, the calculating unit 52 outputs information on the calculated estimated interference area to the specifying unit 54. Furthermore, the calculating unit 52 stores the information on the calculated estimated interference area in the to-be-installed base station information table in the storage unit 53.

The specifying unit 54 specifies frequency channels of the primary system for which the used areas do not overlap with the calculated estimated interference area, that is, white channels, based on the estimated interference area calculated by the calculating unit 52 and based on the used resource table stored in the storage unit 53. Then, the specifying unit 54 outputs information on the specified white channels to the information generating unit 55.

The information generating unit 55 generates a list of the white channels specified by the specifying unit 54, that is, a white space list, and outputs the generated white space list to the transmitting unit 56.

The transmitting unit 56 transmits the white space list generated by the information generating unit 55 to the base station 30-2.

The correcting unit 57 corrects the estimated interference area information stored in the to-be-installed base station information table in the storage unit 53, based on the information on the reception level of the known signal and on the position of the communication device received from the acquiring unit 51.

Operation Example of Control Device

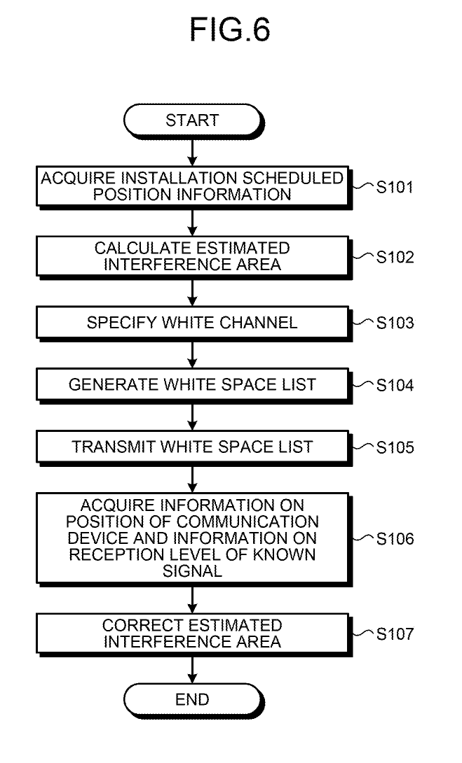

An example of a processing operation performed by the control device 50 with the above-described configuration will be described. FIG. 6 is a flowchart illustrating an example of the processing operation performed by the control device according to the first embodiment.

The acquiring unit 51 in the control device 50 acquires the installation scheduled position information transmitted from the base station 30-2 to be installed (Step S101).

Process of Calculating Estimated Interference Area

The calculating unit 52 calculates the estimated interference area based on the installation scheduled position information received from the acquiring unit 51 and based on the installation position information and the interference area information on the reference base station stored in the reference base station information table (Step S102).

For example, the calculating unit 52 first moves the interference area of the reference base station 30-1 in parallel such that the reference point coincides with the position of the base station 30-2 (see FIG. 1). The area obtained at this time is an area represented by a dotted line in FIG. 1. Furthermore, the calculating unit 52 calculates an expansion value based on the parameter including the separation relation between the installation scheduled position and the installation position of the reference base station. Then, the calculating unit 52 expands the relative area of the parallely-moved reference base station 30-1 by using the calculated expansion value, to thereby calculate the estimated interference area. The expansion value may be an expansion length (that is, a margin) or may be an expansion rate.

For example, a margin M may be obtained by Expression (1) below.

M=(Δd)ⁿ+α (1)

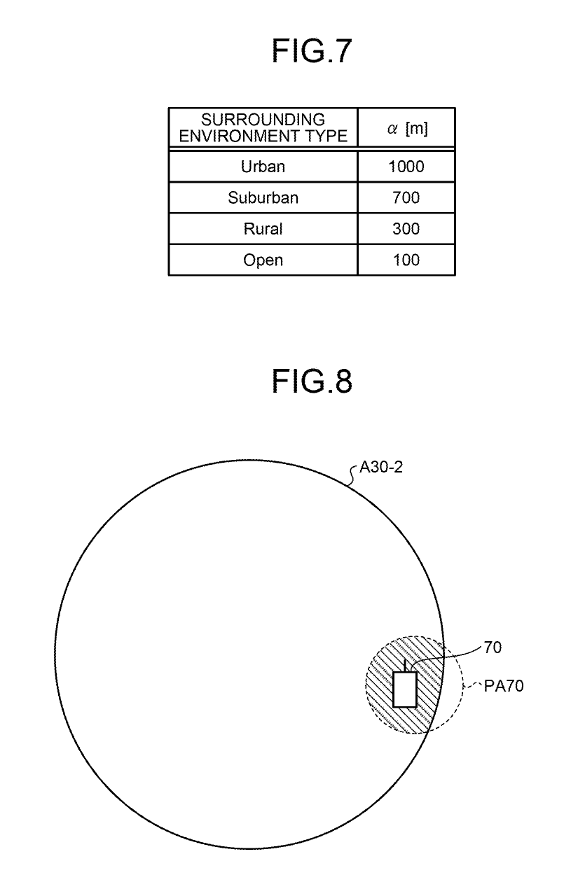

Here, Δd is a separate distance between the installation position of the base station 30-1 and the installation scheduled position of the base station 30-2. Furthermore, n is a value set according to an installation scheduled environment, and is set to a value between 0.4 and 0.6, for example. Moreover, a is a surrounding environment index, and set to a value corresponding to a surrounding environment type of the installation scheduled position. For example, as illustrated in FIG. 7, the surrounding environment type includes a city (Urban), an outer city (Suburban), a country side (Rural), and a visible area (Open). Then, the value of α is different depending on each surrounding environment type. FIG. 7 is a diagram for explaining the surrounding environment index α.

By uniformly expanding the relative area of the parallely-moved base station 30-1 by the calculated margin M, the estimated interference area of the base station 30-2 is calculated.

Process of Specifying White Channel

The specifying unit 54 specifies a frequency channel of the primary system for which the used area does not overlap with the calculated estimated interference area, that is, a white channel, based on the estimated interference area calculated by the calculating unit 52 and the used resource table (Step S103).

For example, the specifying unit 54 specifies that the estimated interference area A30-2 and the used area A10-1 overlap with each other based on the estimated interference area calculated by the calculating unit 52 and the used resource table illustrated in FIG. 3. Then, assuming that a frequency channel set of the primary system includes channels CH1 to CH5, the specifying unit 54 specifies, as the white channels, frequency channels (that is, the channels CH3, CH4, and CH5) except for the channels CH1 and CH2 used in the used area A10-1 in the frequency channel set.

Process of Generating White Space List

The information generating unit 55 forms (generates) a list of the white channels specified by the specifying unit 54, that is, a white space list (Step S104). Then, the transmitting unit 56 transmits the white space list generated by the information generating unit 55 to the base station 30-2 (Step S105).

The base station 30-2 starts a service of the secondary system by using the white space list transmitted from the control device 50. Then, when the base station 30-2 is actually installed and operation of the base station 30-2 is started, the base station 30-2 wirelessly transmits a known signal. A communication device (not illustrated) that has received the known signal transmitted from the base station 30-2 transmits information on the reception level of the known signal and on the position of the communication device to the control device 50 via the base station 30-2.

Then, when the operation of the base station 30-2 is started, the acquiring unit 51 acquires the information on the reception level of the known signal and on the position of the communication device transmitted from the communication device as described above (Step S106).

Process of Correcting Estimated Interference Area

The correcting unit 57 corrects the estimated interference area information stored in the to-be-installed base station information table, based on the information on the reception level of the known signal and on the position of the communication device received from the acquiring unit 51 (Step S107).

For example, the correcting unit 57 compares the reception level of the known signal and a predetermined threshold. If the reception level is smaller than the predetermined threshold, the correcting unit 57 eliminates the position of the communication device or a partial area including the position from the estimated interference area to obtain a corrected estimated interference area. If the reception level is equal to or greater than the predetermined threshold, the correcting unit 57 adds the position of the communication device or a partial area including the position to the estimated interference area to obtain a corrected estimated interference area.

FIG. 8 is a diagram for explaining the process of correcting the estimated interference area. FIG. 8 illustrates a communication device 70. If the reception level of the known signal transmitted from the communication device 70 is smaller than a predetermined threshold, for example, the correcting unit 57 deletes a partial area PA70 including the position of the communication device 70 from the estimated interference area, and employs a resultant area as a corrected estimated interference area. That is, in FIG. 8, a portion obtained by eliminating a hatched area from the estimated interference area A30-2 corresponds to the corrected estimated interference area. In contrast, if the reception level of the known signal transmitted from the communication device 70 is equal to or greater than the predetermined threshold, for example, the correcting unit 57 adds the partial area PA70 including the position of the communication device 70 to the estimated interference area, and employs a resultant area as a corrected estimated interference area. That is, an area obtained by adding a non-hatched portion of the partial area PA70 to the estimated interference area A30-2 corresponds to the corrected estimated interference area.

Method of Measuring Interference Area

A method of actually measuring the interference area will be described below.

The base station 30-1 transmits a known signal by using a frequency channel in the white space list. Then, an administrator of the secondary system measures an interference area by using a measuring device. Specifically, the measuring device is moved to a plurality of measurement points, and the position and the reception level of the known signal are measured at each of the measurement points. If the reception level of the known signal is equal to or greater than a predetermined threshold, the position of the measurement point is included in the interference area. Then, the measuring device sends a report on the positions of the measurement points determined as being included in the interference area to the control device 50. Therefore, the control device 50 can acquire information on the actually measured interference area. Incidentally, the measuring device may send a report on the positions of the measurement points and the reception levels (for example, electric field intensities) to the control device 50, and the control device 50 may specify the interference area based on the received report.

Meanwhile, a measured value measured by the measuring device may include an error. The magnitude of the error may change depending on a calculation method, devices, or a measurement condition used in the measurement process. Therefore, the measuring device sends a report on a parameter related to a measurement error, such as a noise figure (NF) of the measuring device and a moving speed at the time of the measurement, in addition to the measurement result. The control device 50 may correct the interference area by using the parameter related to the measurement error. Alternatively, the control device 50 may calculate the measurement error based on fluctuation in measurement results of a plurality of measurements performed by the measuring device in a single place. Furthermore, as for the measurement error based on the moving speed, it may be possible to obtain a relation between the speed and an error by experiments beforehand, and the control device 50 may calculate the measurement error based on the reported moving speed by using the relation.

Incidentally, a communication device located in the area of the base station 30-1 that is the reference base station may send, as feedback, information on the electric field intensity, fluctuation, or the measurement error to the base station 30-1 or the control device 50, and the base station 30-1 or the control device 50 may correct the interference area based on the information obtained by the feedback.

Furthermore, the above-described communication device 70 may send, as feedback, information on the electric field intensity, fluctuation, or the measurement error to the base station 30-2 or the control device 50, and the base station 30-2 or the control device 50 may correct the estimated interference area based on the information obtained by the feedback.

Moreover, the control device 50 may correct the estimated interference area based on information on the electric field intensity, fluctuation, or the measurement error obtained, by feedback, from the measuring device.

As described above, according to the embodiment, the calculating unit 52 of the control device 50 calculates the estimated interference area of the base station to be installed for the secondary system, based on the installation scheduled position of the base station to be installed, the installation position of the reference base station of the secondary system, and the actually-measured interference area of the reference base station. Then, the specifying unit 54 specifies a channel of the primary system for which a used area does not overlap with the estimated interference area calculated by the calculating unit 52.

With the configuration of the control device 50 as described above, the estimated interference area is calculated by using the installation position of the reference base station and the interference area that are actually measured, so that it is possible to improve the accuracy of calculating the interference area. Furthermore, the estimated interference area of the base station to be installed can be obtained not by measurement but by a calculation process, so that it is possible to reduce the workload of the administrator of the secondary system.

For example, the calculating unit 52 calculates an expansion value based on a parameter including a separation relation between the installation scheduled position and the installation position of the reference base station, and expands the interference area of the reference base station by using the calculated expansion value, to thereby calculate the estimated interference area.

The separation relation may include a separate distance between the installation scheduled position and the installation position of the reference base station. Consequently, it becomes possible to correct the interference area of the reference base station according to the separate distance between the installation scheduled position and the installation position of the reference base station, enabling to calculate the estimated interference area with high accuracy. Furthermore, the separation relation may include a difference in height between the installation scheduled position and the installation position of the reference base station. Consequently, it becomes possible to correct the interference area of the reference base station according to the difference in height between the installation scheduled position and the installation position of the reference base station, enabling to calculate the estimated interference area with high accuracy.

Moreover, the acquiring unit 51 in the control device 50 acquires electric power received by the communication device and information on the position of the communication device with respect to a known signal transmitted by the base station to be installed. Then, the correcting unit 57 corrects the estimated interference area based on the information acquired by the acquiring unit 51.

With the configuration of the control device 50, it is possible to correct the estimated interference area, which has been obtained through the calculation process, by measurement. That is, it is possible to further improve the accuracy of calculating the estimated interference area.

### [b] Other Embodiment

The components of each unit of the first embodiment illustrated in the drawings need not necessarily be physically configured in the manner illustrated in the drawings. In other words, specific forms of distribution and integration of the components are not limited to those illustrated in the drawings, and all or part of the components may be functionally or physically distributed or integrated in arbitrary units depending on various loads or use conditions.

Furthermore, for each processing function performed by each device, all or any part of the processing function may be implemented by a central processing unit (CPU) (or a microcomputer, such as a micro processing unit (MPU) or a micro controller unit (MCU)). Moreover, all or any part of each processing function may be implemented by a program analyzed and executed by the CPU (or a micro computer, such as an MPU or an MCU)) or may be realized by hardware using wired logic.

The control device of the first embodiment may be implemented by a hardware configuration as described below, for example.

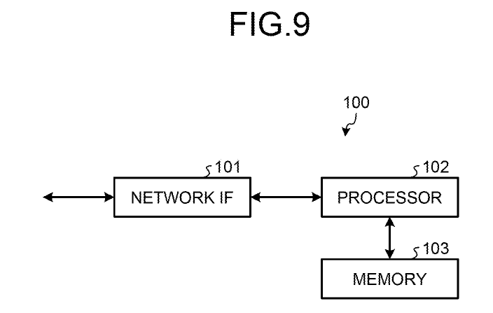

FIG. 9 is a diagram illustrating a hardware configuration example of the control device. As illustrated in FIG. 9, a control device 100 includes a network interface (IF) 101, a processor 102, and a memory 103.

Examples of the processor 102 includes a CPU, a digital signal processor (DSP), and a field programmable gate array (FPGA). Furthermore, examples of the memory 103 include a random access memory (RAM), such as a synchronous dynamic random access memory (SDRAM), and include a read only memory (ROM) and a flash memory.

Various processing functions executed by the control device of the first embodiment may be implemented by executing a program stored in various memories, such as a nonvolatile storage medium, by a process included in an amplifying device. Specifically, programs corresponding to the processes executed by the calculating unit 52, the specifying unit 54, the information generating unit 55, and the correcting unit 57 may be stored in the memory 103, and each of the programs may be executed by the processor 102. Furthermore, the acquiring unit 51 and the transmitting unit 56 are implemented by the network IF 101. Moreover, the storage unit 53 is implemented by the memory 103.

According to an embodiment of the disclosed technology, it is possible to improve the accuracy of calculating an interference area of a secondary system.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device comprising:
a calculating unit that calculates an estimated interference area of a base station to be installed for a secondary system, based on an installation scheduled position of the base station to be installed, an installation position of a reference base station of the secondary system, and an actually-measured interference area of the reference base station; and
a specifying unit that specifies a channel of a primary system for which a used area does not overlap with the calculated estimated interference area.

2. The control device according to claim 1, wherein the calculating unit calculates an expansion value based on a parameter including a separation relation between the installation scheduled position and the installation position, and calculates the estimated interference area by expanding the interference area of the reference base station by using the calculated expansion value.

3. The control device according to claim 2, wherein the separation relation includes a separation distance between the installation scheduled position and the installation position.

4. The control device according to claim 2, wherein the separation relation includes a difference in height between the installation scheduled position and the installation position.

5. The control device according to claim 1, further including:
an acquiring unit that acquires information on electric power received by a communication device with respect to a known signal transmitted from the base station to be installed, and information on a position of the communication device; and
a correcting unit that corrects the estimated interference area based on the acquired information.

6. The control device according to claim 5, wherein the acquiring unit acquires, from the communication device, information on a measurement error of the received electric power or information on fluctuation in a measurement result of the received electric power.

7. The control device according to claim 6, wherein the correcting unit estimates a measurement error based on the acquired information, and corrects the estimated interference area based on the estimated measurement error.

8. The control device according to claim 6, wherein the information on the measurement error includes a moving speed of the communication device.

9. A control method comprising:
calculating an estimated interference area of a base station to be installed for a secondary system, based on an installation scheduled position of the base station to be installed, an installation position of a reference base station of the secondary system, and an actually-measured interference area of the reference base station; and
specifying a channel of a primary system for which a used area does not overlap with the calculated estimated interference area.
